(19) United States
(12) Patent Application Publication
(10) Pub. No.: US 2007/0258002 A1
(43) Pub. Date: Nov. 8, 2007

(54) Imaging subsystem employing a bidirectional shift register

(76) Inventors: Kevin Nay, Fort Collins, CO (US); David K. Campbell, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/417,367

(22) Filed: May 4, 2006

(51) Int. Cl. H04N 3/14; H04N 5/335

(52) U.S. Cl. 348/311

(57) ABSTRACT

An imaging subsystem is provided which includes imaging pixels arranged in rows and columns of an array. Each imaging pixel is configured to generate pixel data corresponding to a portion of an image and transfer the pixel data along its columns toward a first of the rows. Also included is a bidirectional shift register configured to receive the pixel data from the first of the rows of the array and shift the pixel data toward either a first end or a second end of the bidirectional shift register.

### BACKGROUND

Recent advances in digital imaging technology have made consumer electronic devices such as digital still cameras, digital video cameras, digital image scanners and the like more accessible to a greater number of consumers. As a result, for each such type of device, a significant number of manufacturers typically compete to produce equipment exhibiting a combination of price, performance, and functionality most appealing to potential customers.

Many of these imaging devices employ some type of two-dimensional photosensitive cell (or photocell) array to capture one or more images of interest to a user of the device. One example of a photocell array is included in a charge coupled device (CCD). A CCD typically contains thousands or millions of photocells or picture elements (“pixels”), each of which accumulates an electrical charge proportional to the intensity of light incident upon the pixel. Thereafter, each of these electrical charges is retrieved in a serial fashion and converted to a number indicative of the light intensity. Collectively, the numbers associated with each pixel thus represent an image as received by the CCD.

To yield a useful image, a lens similar to that utilized in legacy photographic film cameras is employed to focus the light received by the device onto the CCD or other photocell array. Typically, the lens used is an inversion lens, which inverts the light received by the lens prior to projecting the light onto the array, resulting in an inverted image. Based on this structure, the CCD and surrounding circuitry are organized so that the charge accumulated by each pixel is read in an order beginning with the upper-left corner of the image, and then proceeding from left to right across each row of pixels, one row at a time, ending at the lower-right corner of the image. This order is normally compatible with displaying the image on a display, printing the image, and so forth.

Recently, some digital imaging devices have begun employing reflection or mirror lenses in lieu of simple inversion lenses. Reflection lenses normally employ one or more mirrors to bend or fold the path of the received light within the device before encountering the CCD. Reflection lenses are often utilized to increase the effective focal length of the lens, resulting in the ability to provide telephoto, or magnification, capability, while maintaining a small form factor for the imaging device.

However, due to the changes in the light path caused by a reflection lens, the orientation of the image is often different from that created by an inversion lens. As a result, the CCD or other photocell array may retrieve the accumulated charge from each pixel in an order different from that typically expected. For example, the image may be retrieved beginning with the upper-right or lower-left corner, as opposed to the upper-left corner, thus complicating further display or printing of the image. While the image may be processed to yield the more standard pixel order, such processing requires significant bandwidth and other resources of the device that could be more advantageously employed performing other tasks.

### BRIEF DESCRIPTION OF THE DRAWINGS

FIG. 1 is a block diagram of an imaging subsystem according to an embodiment of the invention.

FIG. 2 is a flow diagram of a method of supplying an imaging subsystem for an imaging device according to an embodiment of the invention.

FIG. 3 is a simplified representation of an image to be captured by an imaging subsystem according to an embodiment of the invention.

FIG. 4 is a block diagram of an imaging subsystem according to an embodiment of the invention in which the captured image of FIG. 3 is inverted.

FIG. 5 is a block diagram of an imaging subsystem according to an embodiment of the invention in which the captured image of FIG. 3 is inverted and reflected.

FIG. 6 is a block diagram of an imaging subsystem according to an embodiment of the invention in which the captured image of FIG. 3 is reflected.

FIG. 7 is a block diagram of an imaging subsystem according to an embodiment of the invention in which the captured image of FIG. 3 is neither inverted nor reflected.

### DETAILED DESCRIPTION

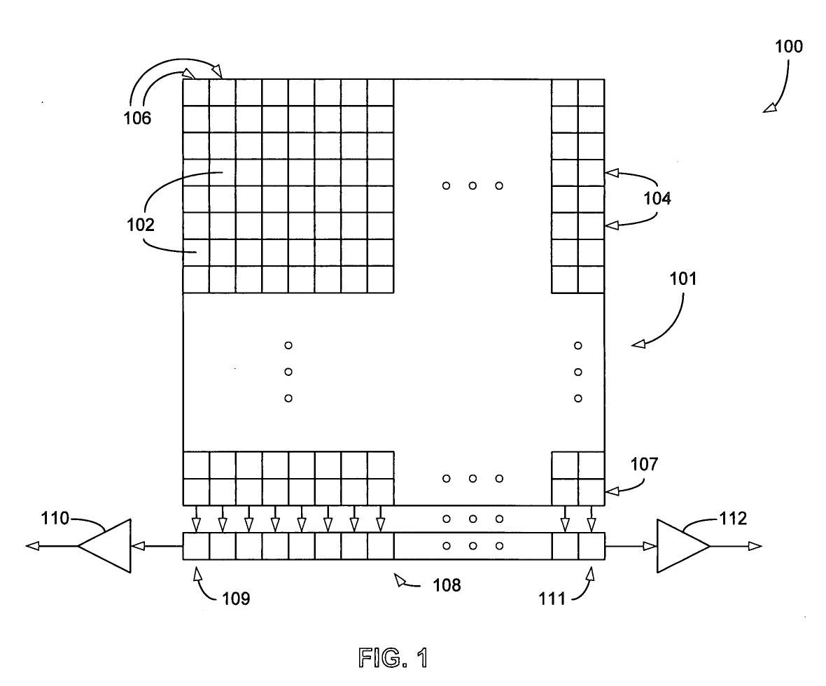

FIG. 1 provides a block diagram of an imaging subsystem 100 according to an embodiment of the invention. Generally, a plurality of imaging pixels 102 are arranged in an array 101 and organized in rows 104 and columns 106. Each of the imaging pixels 102 is configured to generate pixel data corresponding to a portion of an image. Each pixel 102 is also configured to transfer the pixel data along its column toward a first row 107 of the rows 106 of the array 101.

Also included in the imaging subsystem 100 is a bidirectional shift register 108 that is configured to receive the pixel data from the first 107 of the rows 106 of the array 101 and shift the pixel data toward either a first end 109 or a second end 111 of the bidirectional shift register 108.

As will be described in greater detail below, various embodiments of the invention may be employed to supply an imaging device with an imaging subsystem that allows the use of any of multiple lens configurations while delivering the pixel data to the device in a consistent order.

In one embodiment, the imaging subsystem 100 may also include a first amplifier 110 configured to amplify the pixel data shifted from the first end 109 of the bidirectional shift register 108, and a second amplifier 112 configured to amplify the pixel data shifted from the second end 111 of the bidirectional shift register 108. This amplification may allow other portions of the imaging device to more readily process the pixel data describing the captured image.

In another implementation, the array 101 is a CCD array, wherein the imaging pixels 102 are photocells. As a result, the pixel data of each of the imaging pixels 102 is an electrical charge related to an intensity of light received by the imaging pixel 102. This charge is the pixel data representing a portion of an image being captured by the imaging device. In other embodiments, other arrays of imaging pixels employing a different technology may be used to collect and image visible light. Technologies for detecting infrared frequencies, ultraviolet frequencies, and other portions of the non-visible electromagnetic spectrum may be utilized in yet other embodiments.

In one implementation of a CCD, the array 101, the bidirectional shift register 108, and the first and second amplifiers 110, 112 are all fabricated onto a single portion of silicon or other substrate to efficiently transfer the charge related to the light captured by the array 101 to the bidirectional shift register 108 and the amplifiers 110, 112 before the associated data is received and processed by the remainder of the imaging device.

While single imaging pixels 102, each related to a particular portion of an image, are discussed herein, such a discussion does not preclude embodiments which employ arrays 101 in which multiple pixels 102 are associated with a particular area of the image. For example, color CCDs often employ at least three pixels, each sensitive to a particular color, such as red, blue or green, for each identifiable portion of an image.

In some implementations, the number of imaging pixels 102 in the array 101 may number in the thousands or millions. In other embodiments, fewer or more imaging pixels may be utilized, depending on the desired level of resolution for the corresponding imaging device.

The imaging subsystem 100 may be employed in a variety of imaging devices, including but not limited to digital still cameras, digital video cameras, and digital image scanners. Also, any device designed to capture images, but whose primary function is not image-related, such as a cell phone, may benefit from application of the various embodiments described herein.

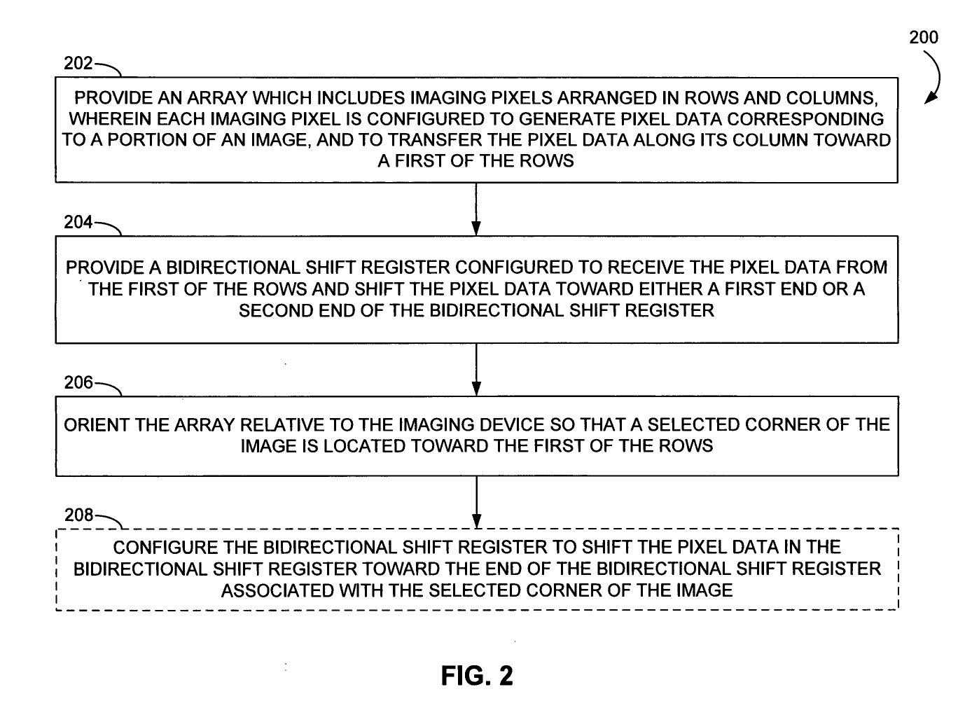

Shown in FIG. 2 is a flow diagram of a method 200 for supplying an imaging subsystem, such as the subsystem 100 of FIG. 1, for an imaging device. An array is provided which includes imaging pixels arranged in rows and columns, wherein each imaging pixel is configured to generate pixel data corresponding to a portion of an image, and to transfer the pixel data along its column toward a first of the rows (operation 202). Also provided is a bidirectional shift register configured to receive the pixel data from the first of the rows and shift the pixel data toward either a first end or a second end of the bidirectional shift register (operation 204). The array is oriented relative to the imaging device so that a selected corner of the image is located toward the first of the rows (operation 206). In one embodiment, the bidirectional shift register is configured to shift the pixel data in the bidirectional shift register toward the end of the shift register associated with the selected corner of the image (operation 208).

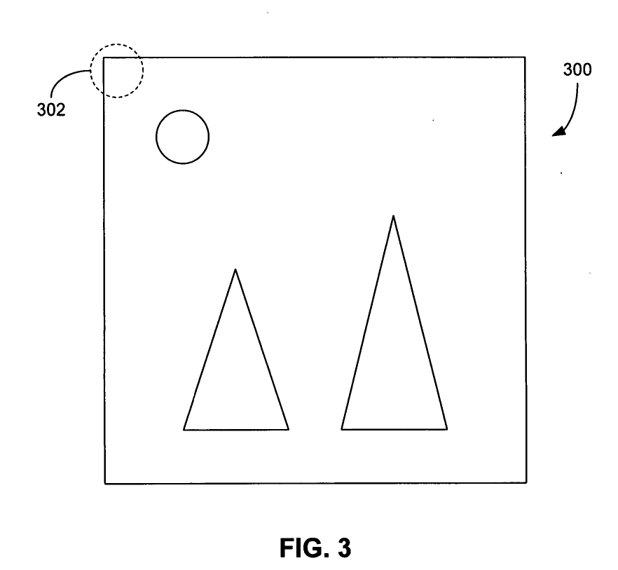

Generally, the imaging device itself provides the frame of reference by which the various portions of the image are identified. For example, with respect to a digital still camera or a digital video camera, how a user of a device views the image by way of a standard view finder or a liquid crystal display (LCD) incorporated into the device typically determines how the image is received into the device. Thus, the upper-left corner of the image as viewed by the user, and as shown in FIG. 3, may be the upper-left corner of the image for purposes of the embodiments described. In one embodiment, the selected corner of the image is the upper-left corner of the image. As a result of this selection in conjunction with the method 200, the imaging device will first transfer pixel data representing the upper-left corner of the image to the imaging device for further processing, display, and the like. In this case, transfer of the pixel data then proceeds along the first row toward the right, then continues at the left of the next row, proceeding in this fashion row by row, ending at the lower-right portion of the image. This transfer order is most ordinarily employed in many imaging devices to allow further processing of the image for eventual use by, or display to, a consumer.

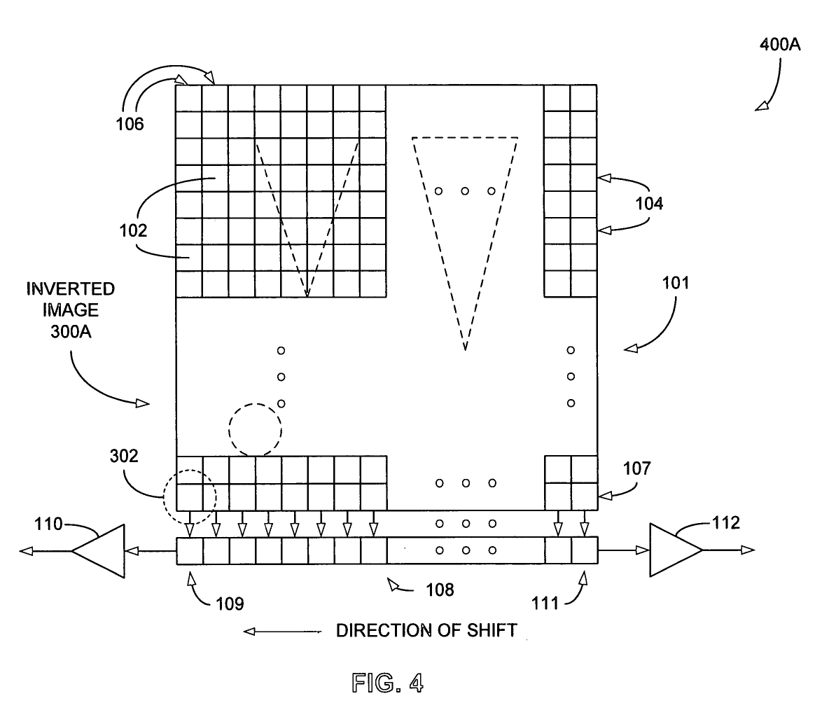

To more fully explain the foregoing embodiments, FIG. 3 provides a simple drawing of a possible image 300 to be captured by an imaging device in the examples provided below. Of particular note is an upper-left corner 302 of the image, which in the embodiments described below is desired to be the first pixel data to be transferred from the imaging subsystem 100, as shown in FIGS. 4-7. In each example, the upper-left corner 302 appears in a different corner of the array 101 as shown in each of the figures, thus describing each of the four possible orientations of the image 300 as captured by the imaging subsystem 100 in relation to the imaging device. In other embodiments, a portion of the image 300 other than the upper-left corner 302 may be selected as the first area of the image 300 to be transferred to the remainder of the imaging device.

In a first example depicted in FIG. 4, the imaging subsystem 100 is placed in a first configuration 400A for capturing an inverted image 300A (i.e., swapped top for bottom, and vice-versa), such as that which may be produced as the result of a standard inversion lens. The inverted image 300A may also result from any odd number of inversions and even number of reflections of the image before encountering the imaging subsystem 100. To allow the pixel data representing the upper-left corner 302 of the image 300A to be transferred first from the imaging subsystem 100 to the remainder of the imaging device, the array 101 is oriented relative to the imaging device so that the pixel data is transferred toward the bottom of FIG. 4, thus adjusting for the inversion. Also, the bidirectional shift register 108 is configured so that the pixel data received by the shift register 108 is shifted from the shift register 108 beginning with the upper-left corner 302 (i.e., toward the left of FIG. 4).

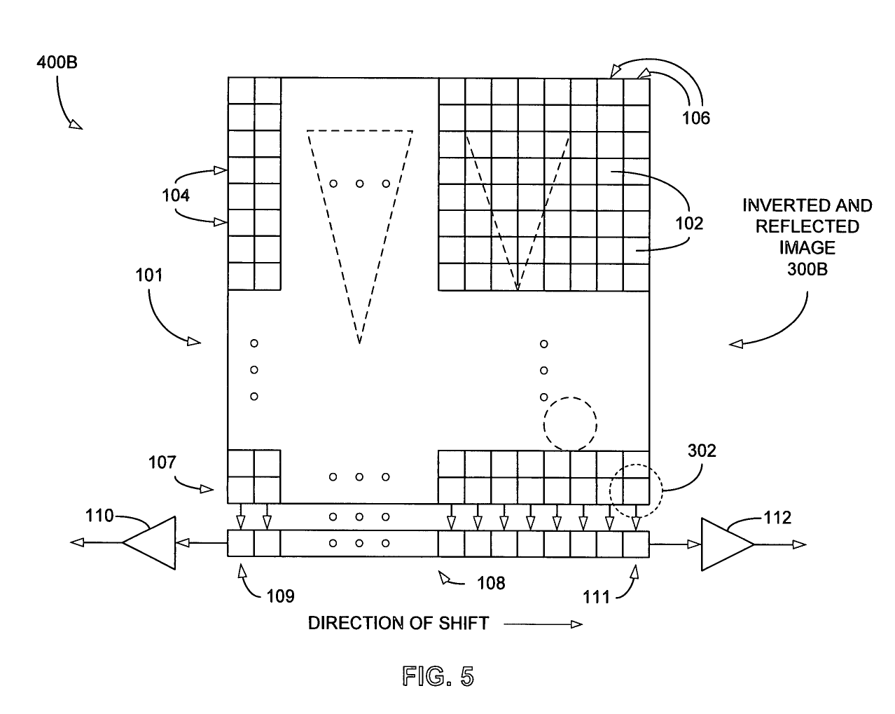

FIG. 5 illustrates an example of a configuration 400B for the imaging system 100 in which the lens utilized in the imaging device produces an inverted (i.e., swapped top for bottom, and vice-versa) and reflected (i.e., swapped left for right, and vice-versa) image 300B. This particular image may be produced by way of an odd number of inversions and an odd number of reflections imposed upon the image 300B. To allow the pixel data for the upper-left corner 302 of the image 300B to be transferred from the imaging subsystem 100 first, the array 101 is oriented relative to the imaging device so that the pixel data is transferred toward the bottom of FIG. 5 to account for the inversion. The bidirectional shift register 108 is then configured so that the pixel data received by the bidirectional shift register 108 is shifted from the shift register 108 beginning with the upper-left corner 302 (i.e., toward the right of FIG. 5), thus accounting for the reflection of the image 300B.

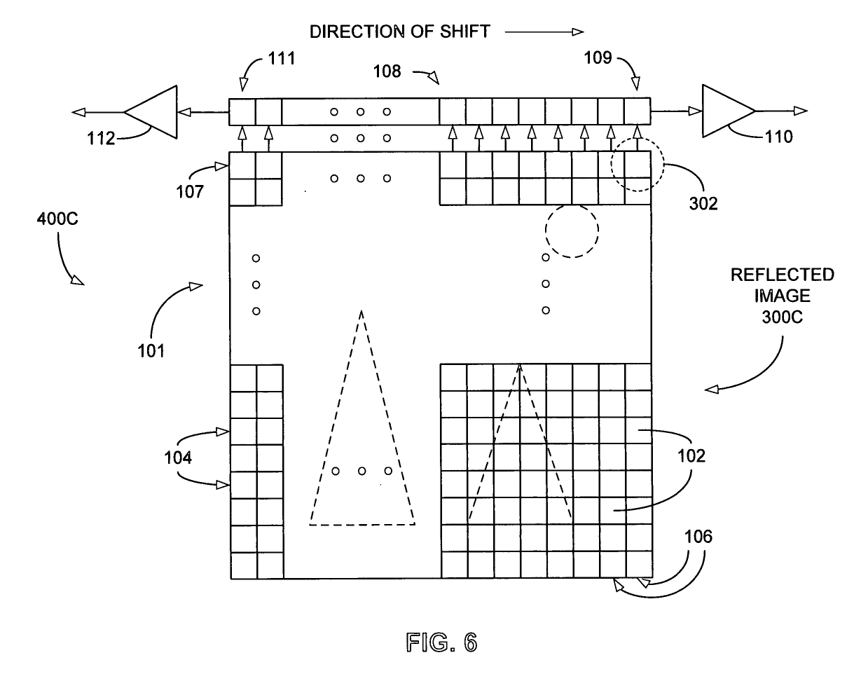

In FIG. 6, the imaging subsystem 100 assumes a configuration 400C compatible with a reflected image 300C, which may result from an even number of inversions and an odd number of reflections of the light being imaged. To allow the pixel data for the upper-left corner 302 of the image 300C to be transferred from the imaging subsystem 100 first, the array 101 is oriented relative to the imaging device so that the pixel data is transferred toward the top of FIG. 6 to account for the lack of inversion. The bidirectional shift register 108 is configured so that the pixel data received by the shift register 108 is shifted from the shift register 108 beginning with the upper-left corner 302 (i.e., toward the right of FIG. 5) to account for the reflection of the image 300C.

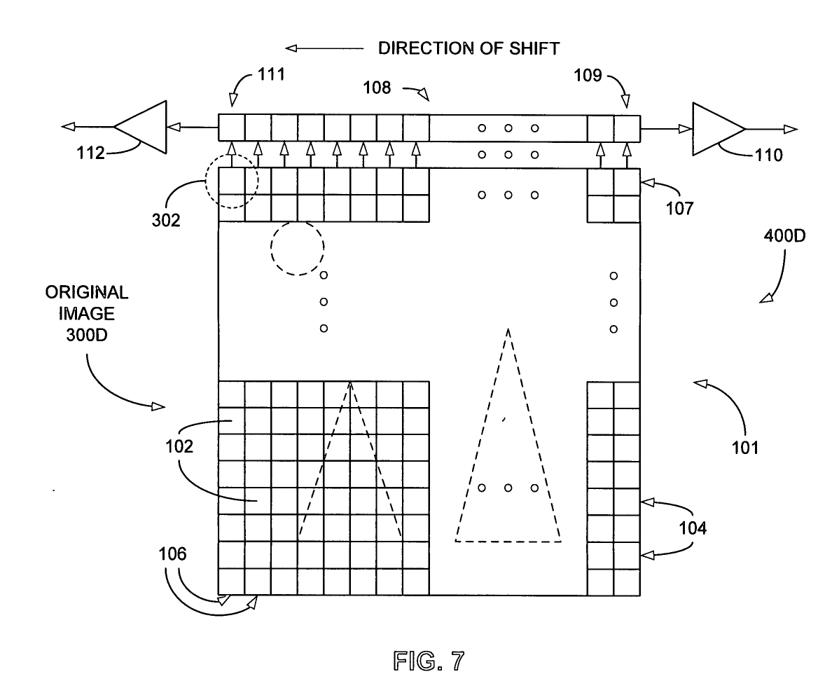

Finally, FIG. 7 illustrates the imaging subsystem 100 when assuming a configuration 400D compatible with a non-inverted, non-reflected image 300D. Such an image may also be produced from an even number of inversions and an even number of reflections of the original image 300. To allow the pixel data for the upper-left corner 302 of the image 300D to be transferred first, the array 101 is oriented relative to the imaging device so that the pixel data is transferred toward the top of FIG. 7. The bidirectional shift register 108 is configured so that the pixel data received by the shift register 108 is shifted from the shift register 108 beginning with the upper-left corner 302 (i.e., toward the left of FIG. 7).

In the embodiments discussed above, the array 101 and the bidirectional shift register 108 are oriented relative to the imaging device such that the corner of the image 300 selected for first transfer from the imaging subsystem 100 is located near the first row of the array 101. Also, the bidirectional shift register 108 is configured to shift its pixel data toward its end located near the selected image corner so that pixel data associated with that corner is shifted out first. With respect to FIGS. 4-7, in imaging devices in which the upper-left corner 302 of the image 300 is to be transferred first, an inversion of the image 300 determines that the pixel data from the columns 106 be transferred toward the bottom, while uninverted images 300 are transferred toward the top. Similarly, a reflection of the image 300 indicates that pixel data within the bidirectional shift register 108 should be shifted to the right, while a lack of reflection dictates a shift to the left.

In one embodiment, the bidirectional shift register 108 is configured to accept at least three different clock phases to allow efficient shifting of electrical charge into the bidirectional shift register 108, and toward either the first end 109 or the second end 111 of the shift register 108. Unidirectional shift registers typically only require two clock phase inputs, as electrical charge may only be shifted toward one end of such a register.

Various embodiments of the present invention provide a single imaging subsystem which can assume several configurations for adapting to a variety of lens types which invert and reflect an image any number of times. As mentioned above, some newer imaging devices currently utilize reflection or mirror lenses in lieu of simple inversion lenses to extend the effective local length of the device without increasing the size of the device. To this end, the reflection lens normally includes one or more mirrors to bend or fold the optical path of the received light within the device prior to the light encountering the array of imaging pixels. In so doing, however, the image is likely to be oriented relative to the array differently from that identified with a simple inversion lens, due to any number of inversions and/or reflections of the image resulting from the lens. Employing the configurations shown herein, the imaging subsystem allows a selectable order of transfer of the generated pixel data from the imaging subsystem for use by the remainder of the associated imaging device. In many cases, this order reduces or eliminates reordering of the image prior to subsequent processing by the device, thus conserving processing bandwidth and other resources of the imaging device that may be utilized for other tasks.

While several embodiments of the invention have been discussed herein, other embodiments encompassed by the scope of the invention are possible. For example, while some embodiments of the invention are described above in conjunction with primarily consumer-oriented applications, such as digital still and video cameras, other types of imaging equipment designed substantially for industrial, scientific, commercial and other markets may also benefit from application or adaptation of the various embodiments, as presented above. Also, while many directional references are made herein (e.g., left, right, upper, lower, and so on), these references are provided merely as an aid to understanding the specific embodiments described herein, and thus do not limit or prohibit the use of other embodiments utilizing differing directional reference frames. Further, aspects of one embodiment may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims.

What is claimed is:

1. An imaging subsystem comprising:
imaging pixels arranged in an array comprising rows and columns, wherein each imaging pixel is configured to generate pixel data corresponding to a portion of an image and transfer the pixel data along its column toward a first of the rows; and
a bidirectional shift register configured to receive the pixel data from the first of the rows of the array and shift the pixel data toward either a first end or a second end of the bidirectional shift register.

2. The imaging subsystem of claim 1, wherein the imaging pixels comprise photocells of a charge coupled device.

3. The imaging subsystem of claim 1, wherein each of the pixel data comprises electrical charge related to an intensity of light received by the corresponding imaging pixel.

4. The imaging subsystem of claim 1, further comprising:
a first amplifier configured to amplify the pixel data shifted out from the first end of the bidirectional shift register; and
a second amplifier configured to amplify the pixel data shifted out from the second end of the bidirectional shift register.

5. The imaging subsystem of claim 1, wherein:
the array is oriented relative to the image such that a selected corner of the image is located near the first of the rows of the array; and
the bidirectional shift register is configured to shift the pixel data in the bidirectional shift register toward the end of the bidirectional shift register associated with the selected corner of the image;
whereby the pixel data is shifted from the bidirectional shift register beginning with the selected corner of the image.

6. The imaging subsystem of claim 1, wherein the selected corner of the image is the upper-left corner of the image.

7. A digital still camera comprising the imaging subsystem of claim 1.

8. A digital video camera comprising the imaging subsystem of claim 1.

9. A digital image scanner comprising the imaging subsystem of claim 1.

10. A method of supplying an imaging subsystem for an imaging device, the method comprising:
providing an array comprising imaging pixels arranged in rows and columns, wherein each imaging pixel is configured to generate pixel data corresponding to a portion of an image and transfer the pixel data along its column toward a first of the rows;
providing a bidirectional shift register configured to receive the pixel data from the first of the rows of the array and shift the pixel data toward either a first end or a second end of the bidirectional shift register; and
orienting the array relative to the imaging device so that a selected corner of the image is located toward the first of the rows.

11. The method of claim 10, further comprising configuring the bidirectional shift register to shift the pixel data in the bidirectional shift register toward the end of the bidirectional shift register associated with the selected corner of the image.

12. The method of claim 10, wherein the selected corner of the image is the upper-left corner of the image.

13. The method of claim 10, wherein the imaging pixels comprise photocells of a charge coupled device.

14. The method of claim 10, wherein each of the pixel data comprises electrical charge related to an intensity of light received by the corresponding imaging pixel.

15. The method of claim 10, wherein the imaging device comprises a digital still camera.

16. The method of claim 10, wherein the imaging device comprises a digital video camera.

17. The method of claim 10, wherein the imaging device comprises a digital image scanner.

18. An imaging subsystem comprising:
means for generating pixel data, wherein each of the pixel data corresponds to one of a plurality of portions of an image, and wherein the portions are organized in rows and columns; and
means for receiving the pixel data from the generating means by row and shifting the pixel data toward either a first direction or a second direction.

19. The imaging subsystem of claim 18, wherein the generating means comprises photocells of a charge coupled device.

20. The imaging subsystem of claim 18, wherein each of the pixel data comprises electrical charge related to an intensity of light associated with the corresponding portion of the image.

21. The imaging subsystem of claim 18, further comprising:
first means for amplifying the pixel data shifted out from the receiving and shifting means in the first direction; and
second means for amplifying the pixel data shifted out from the receiving and shifting means in the second direction.

22. The imaging subsystem of claim 18, wherein:
the receiving and shifting means is configured to shift the pixel data in the first direction; and
the generating means is oriented relative to the image such that the pixel data is shifted from the receiving and shifting means beginning with a selected corner of the image.

23. The imaging subsystem of claim 18, wherein:
the receiving and shifting means is configured to shift the pixel data in the second direction; and
the generating means is oriented relative to the image such that the pixel data is shifted from the receiving and shifting means beginning with a selected corner of the image.

24. A digital still camera comprising the imaging subsystem of claim 18.

25. A digital video camera comprising the imaging subsystem of claim 18.

26. A digital image scanner comprising the imaging subsystem of claim 18.
